(19) United States
(12) Patent Application Publication
(10) Pub. No.: US 2014/0287243 A1
(43) Pub. Date: Sep. 25, 2014

(54) SUPERHYDROPHOBIC COATINGS

(71) Applicants: Stephen Weber, Allison Park, PA (US); Hong Zhang, Pittsburgh, PA (US); Sijia Wang, Pittsburgh, PA (US)

(72) Inventors: Stephen Weber, Allison Park, PA (US); Hong Zhang, Pittsburgh, PA (US); Sijia Wang, Pittsburgh, PA (US)

(73) Assignee: University of Pittsburgh - Of the Commonwealth System of Higher Education, Pittsburgh, PA (US)

(21) Appl. No.: 14/199,857

(22) Filed: Mar. 6, 2014

Related U.S. Application Data
(60) Provisional application No. 61/773,753, filed on Mar. 6, 2013.

(51) Int. Cl. C09D 5/00

(52) U.S. Cl. CPC C09D 5/00
USPC 428/422; 428/421; 524/263

(57) ABSTRACT

A coating composition comprising a colloidal suspension comprising a fluoropolymer and fluorophilic particles in a liquid solvent, wherein the solvent comprises a fluorocarbon, a semifluorous material, or a combination thereof. Also disclosed is a substrate comprising a coated surface, wherein the coated surface comprises a fluorophilic silica particle doped—fluoropolymer film. Further disclosed is a method comprising fluorinating silica particles and preparing a colloidal suspension comprising a fluoropolymer and the fluorinated silica particles in a liquid solvent, wherein the solvent comprises a fluorocarbon, a semifluorous material, or a combination thereof.

This application claims the benefit of U.S. Provisional Application No. 61/773,753, filed Mar. 6, 2013, which is herein incorporated by reference in its entirety.

### ACKNOWLEDGMENT OF GOVERNMENT SUPPORT

This invention was made with government support under grant number CHE-0957038 awarded by the National Science Foundation. The government has certain rights in the invention.

### BACKGROUND

In certain embodiments, surfaces with a water contact angle larger than 150° and a sliding angle less than 10° are considered superhydrophobic. For example, in the case of a lotus leaf, the water-repellent and self-cleaning properties are due to its hydrophobic wax layer on a hierarchically rough microstructure. Generally, a multiscale roughness enables trapping of air under the water droplet, and consequently enhances the surface hydrophobicity geometrically. On the other hand, chemical functionalization helps to reduce the surface energy and to benefit hydrophobic properties of the coatings.

### SUMMARY

One embodiment disclosed herein is a coating composition comprising a colloidal suspension comprising a fluoropolymer and particles in a liquid solvent, wherein the solvent comprises a fluorocarbon, a semifluorous material, or a combination thereof, and the particles are suspension-compatible with the fluorocarbon or the semifluorous material.

Disclosed herein in a further embodiment is a substrate comprising a coated surface, wherein the coated surface comprises a fluorophilic silica particle doped—fluoropolymer film.

Also disclosed herein is a method comprising fluorinating silica particles and preparing a colloidal suspension comprising a fluoropolymer and the fluorinated silica particles in a liquid solvent, wherein the solvent comprises a fluorocarbon, a semifluorous material, or a combination thereof.

The foregoing will become more apparent from the following detailed description, which proceeds with reference to the accompanying figures.

### BRIEF DESCRIPTION OF THE DRAWINGS

FIG. 1 is a schematic diagram depicting one embodiments of the methods disclosed herein.

FIG. 2 shows static contact angle measurement on Teflon® AF 2400 films with 5%, 10%, 15%, 30%, 50%, 70% and 85% (wt %) 510 nm fluorous nanoparticles.

FIGS. 3A and 3B are graphs depicting static CA (3A) and SA (3B) of 4 μL water on spin-coated surfaces. Films were prepared with 120, 310 and 510 nm fluorous nanoparticles, with wt % of 5%, 10%, 15%, 30%, 50%, 70% and 85%.

FIGS. 4A, 4B and 4C are AFM images of (4A) 120 nm, (4B) 310 nm, (4C) 510 nm fluorous nanoparticles (wt %=70%) doped-Teflon® films with 5 μm scan size.

FIG. 5 are schematic representations of solution-cast deposition and spin-coating.

FIG. 6 is a graph showing the static CA and SA of spin coated and solution-cast 120 nm fluorous nanoparticle doped-Teflon® films.

### DETAILED DESCRIPTION

Several problems accompany the preparation of superhydrophobic surfaces such as chemical instability and light-blocking. The processes disclosed herein address these issues. In certain embodiments, the surfaces resulting from the coatings disclosed herein are stable against organic solvents and water. In addition, it is possible to control light scattering by controlling the particle size and layer thickness of the coatings. Transparent films can be made from the coatings. Finally, the surface properties (contact angle, sliding angle) may be dependent on the relative amounts of particle/polymer and also on the application method. In certain embodiments, the relative amount of fluorous particles, based on the total amount of fluorous particles and fluoropolymer, in the coatings may range from 1 to 85 wt %. In certain embodiments, the relative amount of fluorous particles, based on the total amount of fluorous particles and fluoropolymer, in the coatings may range from 70 to 85 wt %.

A wide variety of surface types can be coated, and the resulting films exhibit chemical and superhydrophobicity stability in a wide variety of environments. The coatings are easy to apply to a substrate surface. The suspensions used for coating substrates, prior to use, exhibit a long shelf-life.

Superhydrophobic surfaces do not hold on to water. The superhydrophobic coatings disclosed herein may be applied to glass substrates (e.g., windows, eyeglasses), metallic substrates (e.g., airplane wings (icing resistance), fibrous substrates (e.g. textiles, lignocellulosic), polymeric substrates (e.g., plastic or elastomeric), or composite substrates(e.g., fiber-reinforced composites, metal/plastic composites). Spherical silica nanoparticles are chemically modified to make their surface “fluorous” or “fluorophilic.” For example, a fluoroalkyl or fluorophenyl layer or matrix may be coupled (e.g., via chemical bonding such as covalent bonding) to the particle surface. In one embodiment, the fluorophilic nanoparticles (FNP) include a fluoroalkyl monolayer. In one embodiment, the fluorophilic nanoparticles may be made by reacting the nanoparticles with a fluoroalkyl triethoxysilane. Illustrative fluoroalkyl triethoxysilanes include 1H, 1H, 2H, 2H-perfluorooctyltriethoxysilane and 1H, 1H, 2H, 2H-perfluorotetradecyltriethoxysilane.

In one embodiment, a suspension is made with fluorophilic particles, a soluble fluoropolymer (e.g. Teflon AF 2400 (DuPont)), and a fluorocarbon or semifluorous solvent. Such suspensions are stable. Preferred solvents are semifluorous or mixtures of fluorous and semifluorous solvents, or fluorous solvent with an additive of the carboxylic acid Krytox 157 (FSL, M, or H from DuPont). Films are made on substrates by casting/solvent evaporation, spin coating, spraying, dip-coating, or other coating techniques. The film surfaces display various degrees of superhydrophobicity.

In certain embodiments, the particles are monodisperse. In certain embodiments, the fluorous nanoparticles may have a particle size range of 20-500 nm. In the case of spin-coated films, a preferred particle size range is 120-500 nm. In the case of cast films, a preferred particle size is 120 nm.

The fluorocarbon or semifluorous solvent may constitute the continuous phase of the suspension. Illustrative solvents include perfluorocarbons (e.g., perfluoroalkanes such as perfluorohexane (e.g., FC-72), perfluorooctane (e.g., PF5080), alkoxyperfluorobutane (e.g., methoxyperfluorobutane (e.g., HFE-1700), 2-trifluoromethyl-3-ethoxydodecaflurohexane (e.g, HFE-7500)), perfluorocyclooctylether (C8F16O) and mixtures thereof (e.g., a mixture of perfluorooctane and perfluorocyclooctylether (e.g., FC-770).

Illustrative fluoropolymers include polytetrafluoroethylene, perfluoroalkoxy, copolymer of tetrafluoroethylene and dioxole (e.g., poly[4,5-difluoro-2,2-bis(trifluoromethyl)-1,3-dioxole-co-tetrafluoroethylene (e.g., Teflon®AF 2400, Teflon® 1600) and fluorinated ethylene propylene (e.g., Teflon® FEP). Very thin or thick coatings are possible. The coatings also may have a decomposition temperature >300 deg C. In certain embodiments, the resulting coatings are transparent or near-transparent.

Generally, fluorous solvents and organic solvents are not miscible in significant proportions. Moreover, organic compounds functionalized with certain fluorocarbon ponytails [(CH₂)ₘ(CF₂)ₙ₋₁CF3] tend to have reduced solubility parameters and consequently are compatible with fluorous solvent. Disclosed herein are processes for utilizing fluoroalkyl end-capped nanoparticles for preparing superhydrophobic Teflon AF 2400 films. The films were doped with FNPs to create surface roughness. As a commercially available perfluoropolymer, Teflon AF 2400 is known for its thermal and chemical stability, mechanical robustness, as well as the low surface energy (˜16 mN/m) (34). A basic protocol is to dissolve/suspend Teflon AF 2400 and FNPs in FC-72 solvent, followed by spin coating on glass microscope slides or solution-casting in flat-bottomed dishes. The dependence of surface wettability on the particle sizes and the weight percentages of FNPs (wt % FNP) were investigated, and surface morphologies were determined by atomic force microscopy (AFM).

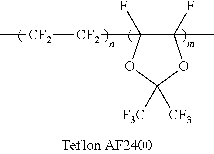

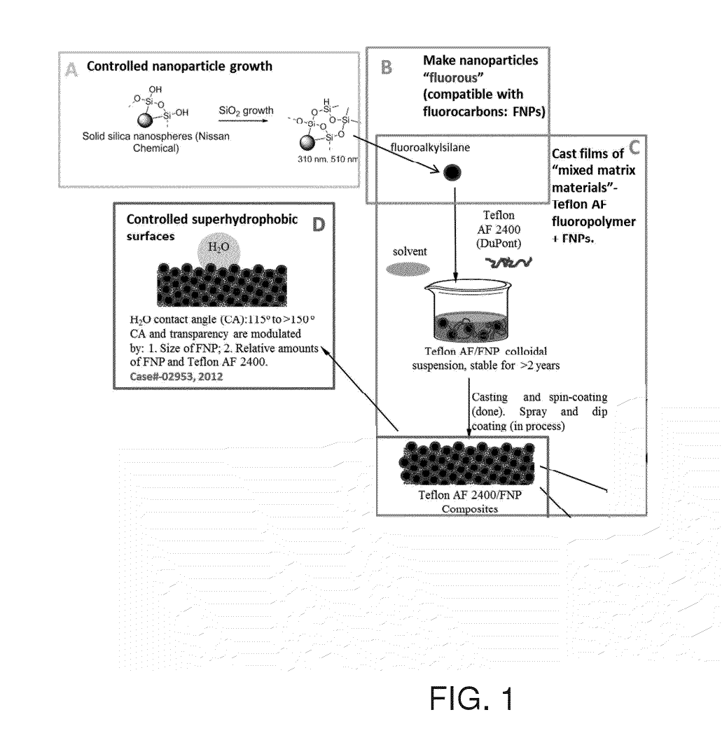

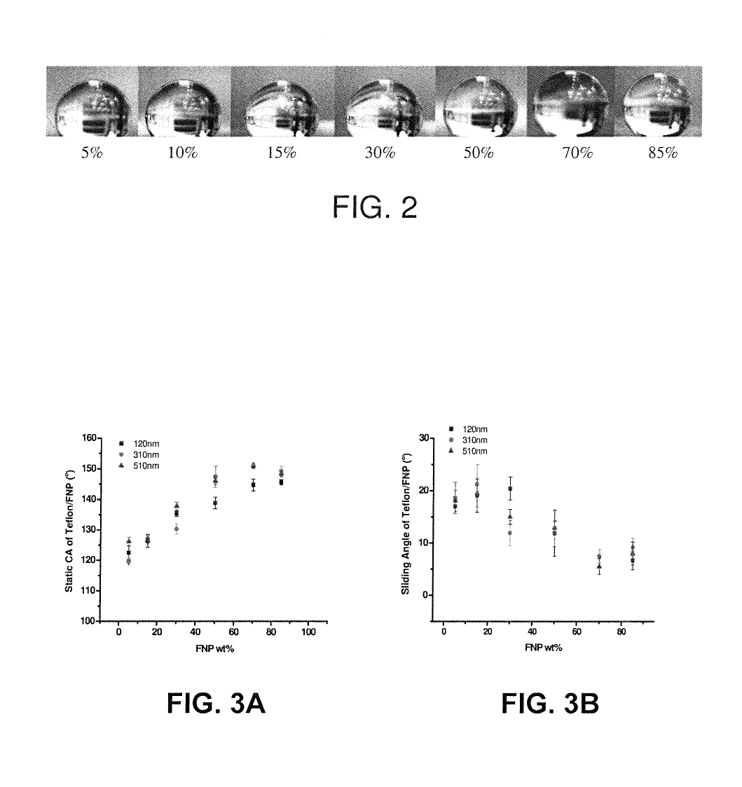

A schematic of an embodiment of the methods and products disclosed herein is shown in FIG. 1.

A: Nanoparticle growth from small sizes (commercially available SiO₂) to mono-disperse and larger particles (SiO₂) by improved Stober method.
The method includes growing particles from a monodisperse starting suspension with particle diameter d₁ to a new monodisperse suspension with diameter d₂, d₂>d1.

### Benefits of Controlled Size:

1. Control of H₂O contact angle;
2. Control of film/coating transparency (important for coatings in optical applications).
B: Modify SiO₂ nanoparticles by a fluorous silane to yield fluorophilic nanoparticles (FNP) with fluoroalkyl monolayer.

### Benefits of Fluorous Modification:

1. FNPs are compatible with fluorocarbons, semifluorous solvents, and their mixtures. FNP colloid in a solvent mixture [HFE7100 (semifluorous) and PF5080/FC-77(C8F18)] is stable for more than 2 years. Excellent colloidal stability allows the preparation of homogeneous Teflon AF 2400/FNP composite films and coatings.
C: Preparation of Teflon AF 2400/FNP films and coating solutions.
This aspect of the process results in stable suspensions of fluoropolymer/FNPs.
The Teflon AF/FNP composites start with a fluorous suspension containing Teflon AF 2400 and FNPs. Teflon AF/FNP composite materials have excellent chemical (organic, aqueous), thermal (>300° C.), and mechanical stability (DMA data).
D: Application of Teflon AF 2400/FNP composites as hydrophobic/superhydrophobic coatings for self-cleaning (windows, eyeglasses, airplane wings, textiles, etc.)

### Benefits:

1. The wt % and particle size of FNP can be adjusted to achieve H₂O contact angle from 115° to >150° according to applications.
2. The transparency of the coating can be controlled by adjusting the wt % and size of FNP according to applications.
3. Homogeneous solution allows easy environmental and industrial applications (spin coating, sprays are possible).

### EXAMPLES

To investigate the dependence of particle size on surface wetting properties, fluoroalkyl modified silica particles (FNPs) with different diameters were used for film preparation. Colloidal silica with 50 and 120 nm diameters (IPA-ST-L and IPA-ST-ZL respectively) were gifts from Nissan Chemical Co. (Tokyo, Japan), and larger particles (310 and 510 nm in diameter) were synthesized by sol-gel process. To prepare the 510 nm silica particles, a solution of 5.6 ml tetraethoxysilane (TEOS) and 19.4 ml ethanol was stirred vigorously in a 500 ml flask, followed by adding a mixture of 6 ml H₂O and 18 ml ethanol dropwise. The hydrolysis step proceeded for 10 min. A solution of ammonium hydroxide (2 ml) was added slowly afterwards and the reaction proceeded at room temperature for 5 hour. The prepared particles were centrifuged at 6000 rpm for 30 min, and then re-suspended in fresh ethanol to wash away unreacted TEOS. 310 nm silica particles were grown from the 120 nm “nucleus” with sol-gel process. A solution of 120 nm silica (IPA-ST-ZL, 2 ml) was stirred with 27 ml isopropanol at room temperature, followed by adding 15 ml TEOS. Then a mixture of 1.5 ml ammonium hydroxide in a cosolvent of 20 ml isopropanol and 6 ml H₂O was added as catalyst. The reaction proceeded for 5 hour and the workup process was taken likewise.

In an alternative embodiment, a different method was employed to grow nanoparticles. For example, to prepare 151 nm silica nanoparticles, a colloidal suspension of silica nanoparticles (IPA-ST-ZL, 113 nm, 2 mL) was added to a vigorously stirred solution of ethanol (50 mL) at room temperature. Then a solution of ammonium hydroxide (28.0-30.0%, 6 mL) in a mixture of ethanol (25 mL) and water (8 mL) was added dropwise with stirring. 3.9 mL of TEOS was added slowly (0.0041 mL/min) into the system by a syringe pump. After all the TEOS was added, the mixture was stirred at room temperature for 1 hour. The modified nanoparticles were centrifuged at 6,000 rpm for 30 min and then resuspended in ethanol (30 mL) for three cycles to remove excess reagents.
A typical procedure of particle modification includes: 1) suspend particles (3.0 g) into a cosolvent of isopropanol (35 ml) and HFE-7100 (25 ml); 2) add 1H, 1H, 2H, 2H-perfluorooctyltriethoxysilane (4 ml for 50 nm; 2 ml for 120 nm, 310 nm and 510 nm silica particles) as fluoroalkane tags; and 3) add ammonium hydroxide (28.0-30.0%, 10 ml) in 25 ml isopropanol to modulate the pH to about 10. The reaction was then refluxed in an oil bath at 80° C. for 3 days. The modified nanoparticles were centrifuged (1000 rpm, 50 min for 50 nm FNPs; 6000 rpm, 30 min for 120, 310 and 510 nm FNPs) and resuspended in fresh washing solvent (ethanol: HFE-7100=2:1; v/v) for 3 cycles to wash away excess silane reagent.
Microscope glass slides (25×19×1 mm) from Fisher Scientific (Hampton, N.H.) were used as film casting substrates. To get rid of the inference from dust and impurities, the glass slides were cleaned with a heated mixture of concentrated sulfuric acid and hydrogen peroxide (Piranha solution) at a ratio of 3:1 (v/v). (Caution: Piranha solution reacts violently with organic compounds and should be handled with extreme care.) This process was performed at 80° C. for 30 min, followed by rinsing with D.I. water to get rid of the residues. Cleaned glass slides were reserved in fresh ethanol.
To prepare the coating solution, FNPs (120, 310 and 510 nm) were mixed with Teflon AF 2400 in a solvent of FC-72 (2.5 ml) at room temperature to form a homogeneous suspension. In each entry, the total mass of FNP and Teflon AF 2400 was 62.5 mg, with wt % FNP varying from 5% to 85%. Films were prepared by spin coating at 3000 rpm on the substrates layer by layer (4 layers in total) at a constant spin time of 40 sec, before they were cured at 120° C. overnight. The wetting properties were later characterized with VCA 2000 video contact angle system (Advanced Surface Technology, Inc. Billerica, Mass.) with 4 μL water droplets. Advancing and receding angles were measured by automatically adding/withdrawing water with a needle in the water droplet. Contact angles were measured when water drop started to expand/contract. Sliding angle was calculated as the averaged difference in advancing and receding angle. All values were averaged over three different spots. Surface morphology was investigated with Philips XL-30 SEM (Hillsboro, Oreg.) after being sputter-coated with palladium. AFM were conducted by PPG Industries (PA).

### RESULTS

### Wetting Properties

Static contact angles (static CA) and sliding angles (SA) were measured on films with FNPs of different diameters (120, 310 and 510 nm) and weight percentages (5%, 10%, 15%, 30%, 50%, 70% and 85%).
As shown in FIG. 3a, the static CA increase with wt % FNP. For the 510 nm FNP doped Teflon films, for instance, those with 5%, 10%, 15%, 30% and 50% FNPs have static CA of 126.2±1.4, 126.6±0.7, 137.8±1.3 and 146±1.1°, respectively.
Superhydrophobicity is achieved on the film with 70% 510 nm FNP with static CA of 151.1±0.7° and SA of 5.5±1.5°. To further increase the weight percentage of FNP, however, decrease the static CA to 148.4±1.0°. This trend is also observed in 310 nm FNP doped Teflon films, where the 70% film (static CA 150.7±0.6°) is slightly more hydrophobic than the 85% film (static CA 149.2±1.5°). The influence of particle sizes and weight percentages on sliding angles (SA) (FIG. 3b) is similarly observed. The smallest SAs are reached on 70% FNP doped films in each group, and those with 85% FNPs also have decent water repellent performance with SA less than 10°. This is in accordance with the observation that water droplets are more prone to roll off surfaces with high percentage of particles.

### Surface Morphology Analysis

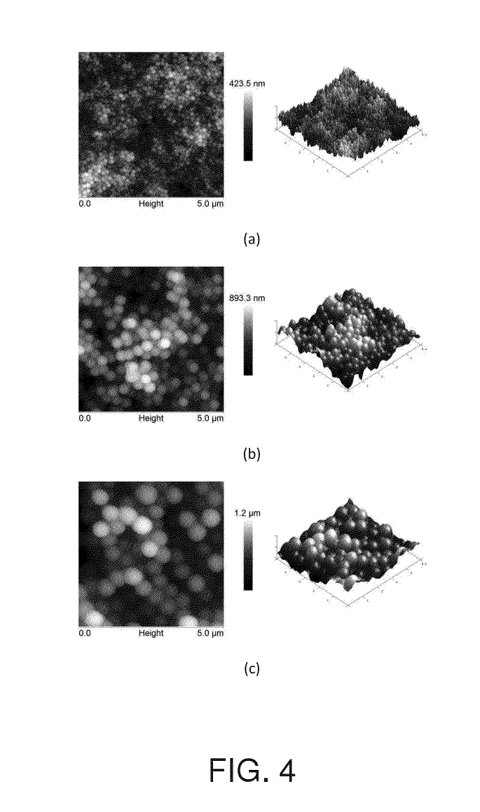

AFM images were used to investigate the effect of surface morphology on film wettability. According to the 3D images of 70% FNPs doped Teflon films (FIG. 4), spherical particles pile up randomly to form clusters, instead of forming mono- or multilayer arrays on the surface. This prediction is further proved by the fact that the experimental RMS roughness is much larger than the calculated values based on a particle crystal model (Table 1).

TABLE 1
Summary of wettability measurements and comparison
to calculated values.

| | RMS | RMS | | |
|---|---|---|---|---|
| | (experimental, | (theoretical, | | Static CA |
| FNP | nm)* | nm)^{‡} | r^{§} | (°) |
| 120 nm | 60.8 | 14.8 | 1.436 | 144.7 ± 1.9 |
| 310 nm | 158 | 38.1 | 1.552 | 150.7 ± 0.6 |
| 510 nm | 199 | 62.7 | 1.480 | 151.1 ± 0.7 |

*RMS (experimental) = [Σ(Zᵢ − Zₐᵥₑ)²/N]^{1/2}, where Zₐᵥₑ = Z value at the central plane, Zᵢ = local Z value, and N = number of points within the given area.
^{‡}RMS (theoretical) ≈ 0.123D (35), based on close - packed crystal model
^{§}r = Image Surface Area/Image Projected Area

As in Table 1, the wettability of films is not affected significantly by surface morphology. As seen, there is a minor variance in static CA from 144.7±1.9 to 151±0.7° as the RMS roughness increases from 60.8 to 199 nm. The surface roughness was evaluated with Wenzel roughness factor, r, which is the ratio of real surface area and the corresponding projected area. As the particle sizes increase from 120 to 510 nm, the changes in r factors are quite small (1.436 to 1.552). The Wenzel roughness factor r is a constant in a hemispherical close-packed model and r≈1.9. The r value on surfaces with randomly packed particles is supposed to be larger than 1.9, considering its higher effective roughness. This indicates an underestimation of r values in the AFM measurement, where r≈1.4˜1.5. This is likely due to the fact that the AFM tip only probed the top of the particles and failed to insert into the narrow cavities.

### Solution-Cast Deposition

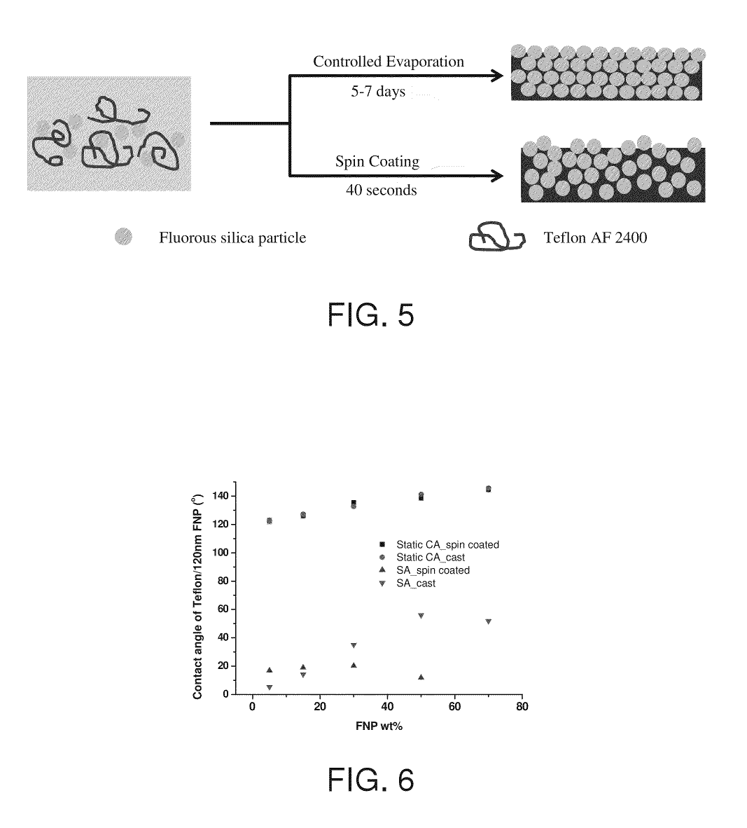

FNPs doped Teflon AF 2400 Films were also prepared by solution-cast deposition, in which the coating solution evaporated slowly in an optically flat glass dish for 5-7 days. To get controlled evaporation, an environment of saturated solvent vapor is required and the casting platform was kept steady during the casting process. Apparently, the process of solution-cast deposition is much slower compared with spin coating. Consequently, FNPs have enough time to array and organize on the substrate in a solution-cast deposition process. In a spin-coating process, however, the mobility of FNPs is diminished because of the fast evaporation of solvent (FIG. 5). In our case, the boiling point of the solvent was very low (b.p FC-72=56° C., at 1 atm), therefore its evaporation is much faster in the open air than in the half-sealed containers. As shown in FIG. 6, the SAs on spin-coated films are smaller than those on cast films with the same wt %_{FNP}, even though there are no significant differences between their static CAs. This is in accordance with the observation that water drops were more prone to roll off on spin coated films.

In view of the many possible embodiments to which the principles of the disclosed invention may be applied, it should be recognized that the illustrated embodiments are only preferred examples of the invention and should not be taken as limiting the scope of the invention.

What is claimed is:

1. A coating composition comprising a colloidal suspension comprising a fluoropolymer and particles in a liquid solvent, wherein the solvent comprises a fluorocarbon, a semifluorous material, or a combination thereof, and the particles are suspension-compatible with the fluorocarbon or the semifluorous material.

2. The coating composition of claim 1, wherein the particles have a particle size range of 20-500 nm.

3. The coating composition of claim 1, wherein the particles are present in an amount of 70 to 85 wt %, based on the total amount of particles and fluoropolymer.

4. The coating composition of claim 1, wherein the solvent comprises a perfluorocarbons, an alkoxyperfluorobutane, a perfluorocycloether, or a mixture thereof.

5. The coating composition of claim 1, wherein the fluoropolymer comprises perfluoroalkoxy, copolymer of tetrafluoroethylene and 2,2-bis-trifluoromethyl-4,5-difluoro-1,3-dioxole, Hyflon AD, Cytop, fluorinated ethylene propylene, or other similar polymers, or a mixture thereof.

6. The coating composition of claim 1, wherein the particles comprise silica particles fluorinated with a fluoroalkyl triethoxysilane.

7. The coating composition of claim 1, wherein the particles comprise a fluoroalkyl or fluorophenyl motif on the surface of the particles.

8. A substrate comprising a coated surface, wherein the coated surface comprises a fluorophilic silica particle doped—fluoropolymer film.

9. The substrate of claim 8, wherein the fluoropolymer comprises polytetrafluoroethylene, perfluoroalkoxy, copolymer of tetrafluoroethylene and dioxole, fluorinated ethylene propylene, or a mixture thereof.

10. A method comprising fluorinating silica particles and preparing a colloidal suspension comprising a fluoropolymer and the fluorinated silica particles in a liquid solvent, wherein the solvent comprises a fluorocarbon, a semifluorous material, or a combination thereof.

11. The method of claim 10, further comprising applying the colloidal suspension to a substrate.

12. The coating composition of claim 1, wherein the particles have a particle size range of 20-500 nm, the particles are present in an amount of 70 to 85 wt %, based on the total amount of particles and fluoropolymer, the solvent comprises a perfluorocarbons, an alkoxyperfluorobutane, a perfluorocycloether, or a mixture thereof, and the fluoropolymer comprises perfluoroalkoxy, copolymer of tetrafluoroethylene and 2,2-bis-trifluoromethyl-4,5-difluoro-1,3-dioxole, Hyflon AD, Cytop, fluorinated ethylene propylene, or other similar polymers, or a mixture thereof.

13. The coating composition of claim 12, wherein the particles comprise silica particles fluorinated with a fluoroalkyl triethoxysilane.

14. The coating composition of claim 12, wherein the particles comprise a fluoroalkyl or fluorophenyl motif on the surface of the particles.
